(19) United States
(12) Patent Application Publication
(10) Pub. No.: US 2017/0161759 A1
(43) Pub. Date: Jun. 8, 2017

(54) AUTOMATED AND ASSISTED GENERATION OF SURVEYS

(71) Applicant: International Business Machines Corporation, Armonk, NY (US)

(72) Inventors: Yang Li, Dublin (IE); Yuzhuo Li, Dublin (IE); Alice-Maria Marascu, Dublin (IE); Miguel J. Monasor, Dublin (IE); Bogdan E. Sacaleanu, Dublin (IE)

(21) Appl. No.: 14/957,683

(22) Filed: Dec. 3, 2015

(51) Int. Cl. G06Q 30/02; G06F 17/27; G06F 17/30

(52) U.S. Cl. CPC G06Q 30/0203; G06F 17/3071; G06F 17/30699; G06F 17/30654; G06F 17/2705; G06F 17/30693

(57) ABSTRACT

An approach to automatically generating a survey. The approach collects input information from a survey designer and uses the input to generate sections for the survey. The approach then selects question from related archived surveys and generates new questions from internal and/or external data sources to assemble the survey. The approach can perform the section generation analysis and the question selection/generation automatically and/or tuned by a survey designer. The approach distributes the completed survey to survey takers and feedback is provided based on metrics associated with characteristics exhibited by the survey takers while taking the survey. The feedback allows the approach to improve survey quality.

### BACKGROUND OF THE INVENTION

The present invention relates generally to the generation of surveys and more specifically, to automatic or assisted generation of surveys based on survey designer input and optionally, based on the user behavior analysis.

The intent of a Survey is to collect data for the analysis of a group or area. A survey comprises a set of questions divided into sections and associated with a specific topic. The question type associated with a survey can vary, e.g., multiple choice, rating scales, free form text responses, etc. Survey systems provide for the manual generation of surveys through a designer tool and a survey designer defining the different sections and the associated questions of the survey. The completed survey is disturbed to the group or area of individuals for completion and the results returned for analysis.

The quality, and subsequent value, of the survey is a function of the survey designer's knowledge of the survey topic. Frequently, the survey designer is not an expert on the survey topic and relies on manually selecting and/or preparing questions based on related topics or selecting a predefined survey template associated with a related topic. The survey creation system is inefficient because the survey designer manually chooses the questions for the survey, resulting in a significant investment in time by the survey designer and a lower quality survey based on the limits of data mining associated with a manual selection system.

### SUMMARY

According to an embodiment of the present invention, method for automatically preparing a survey, the method comprising: receiving, by a survey design computer, survey configuration information associated with a survey topic; generating, by the survey design computer, a plurality of survey sections, based on the survey configuration information, for the survey; generating, by the survey design computer, a plurality of survey questions, based on the configuration information and the plurality of survey sections; generating, by the survey design computer, a survey wherein the plurality of survey sections are associated with a portion of the plurality of survey questions, respectively; and outputting, by the survey design computer, a survey towards one or more user survey computers.

According to another embodiment of the present invention, a computer program product for automatically preparing a survey, the computer program product comprising: one or more computer readable storage media and program instructions stored on the one or more computer readable storage media, the program instructions comprising: program instructions to, receive, by a survey design computer, survey configuration information associated with a survey topic; program instructions to, generate, by the survey design computer, a plurality of survey sections, based on the survey configuration information, for the survey; program instructions to, generate, by the survey design computer, a plurality of survey questions, based on the configuration information and the plurality of survey sections; program instructions to, generate, by the survey design computer, a survey wherein the plurality of survey sections are associated with a portion of the plurality of survey questions, respectively; and program instructions to, output, by the survey design computer, a survey towards one or more user survey computers.

According to another embodiment of the present invention, a computer system for automatically preparing a survey, the computer system comprising: one or more computer processors; one or more computer readable storage media; program instructions stored on the one or more computer readable storage media for execution by at least one of the one or more computer processors, the program instructions comprising: program instructions to, receive, by a survey design computer, survey configuration information associated with a survey topic; program instructions to, generate, by the survey design computer, a plurality of survey sections, based on the survey configuration information, for the survey; program instructions to, generate, by the survey design computer, a plurality of survey questions, based on the configuration information and the plurality of survey sections; program instructions to, generate, by the survey design computer, a survey wherein the plurality of survey sections are associated with a portion of the plurality of survey questions, respectively; and program instructions to, output, by the survey design computer, a survey towards one or more user survey computers.

### BRIEF DESCRIPTION OF THE DRAWINGS

FIG. 1 is a functional block diagram generally depicting an automated and assisted survey generation environment, in accordance with an embodiment of the present invention;

FIG. 2A-B is a functional block diagram depicting a survey designer component and a question miner component associated with a survey generation environment, in accordance with an embodiment of the present invention;

FIG. 3 is a functional block diagram depicting a user survey associated with a survey generation environment, in accordance with an embodiment of the present invention;

FIG. 4 is a flowchart depicting operational steps of a method for automatically assisting in the generation of a survey, within a survey generation environment, in accordance with an embodiment of the present invention; and

FIG. 5 is a block diagram of components of a survey design computer and a user survey computer of a survey generation computing environment, in accordance with an embodiment of the present invention.

### DETAILED DESCRIPTION

The embodiments depicted and described herein recognize the benefits of an automated and assisted method and framework for a survey generation system. Utilizing data associated with previous surveys and information accessible online, the automated system generates survey sections and questions for the survey sections based on a survey designer provided title and description of the survey topic. These embodiments provide for reduced cost and increased quality of survey generation based on preparing a survey in a shorter amount of time from a broader base of survey research data. It should be noted that the survey generation system also provides a survey quality improvement aspect based on a survey feedback system incorporated into the user survey.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

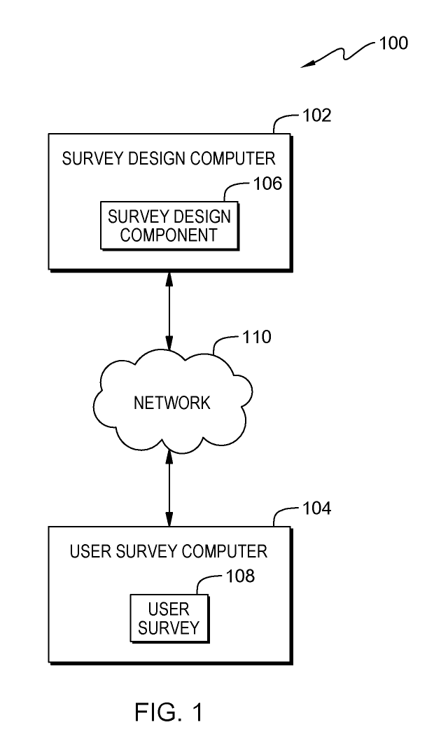

FIG. 1 is a functional block diagram illustrating, generally, an embodiment of a survey generation environment 100. The survey generation environment 100 comprises a survey design component 106 operating on a survey design (i.e., survey generator) computer 102, one or more user surveys 108 operating on one or more user survey computers 104 and a network 110 supporting communications between the survey design computer 102 and the one or more user survey computers 104.

Survey design computer 102 can be a standalone computing device, management server, a web server, a mobile computing device, or any other electronic device or computing system capable of receiving, sending, and processing data. In other embodiments, Survey design computer 102 can represent a server computing system utilizing multiple computers as a server system. In another embodiment, survey design computer can be a laptop computer, a tablet computer, a netbook computer, a personal computer, a desktop computer or any programmable electronic device capable of communicating with other computing devices (not shown) within survey design environment 100 via network 110.

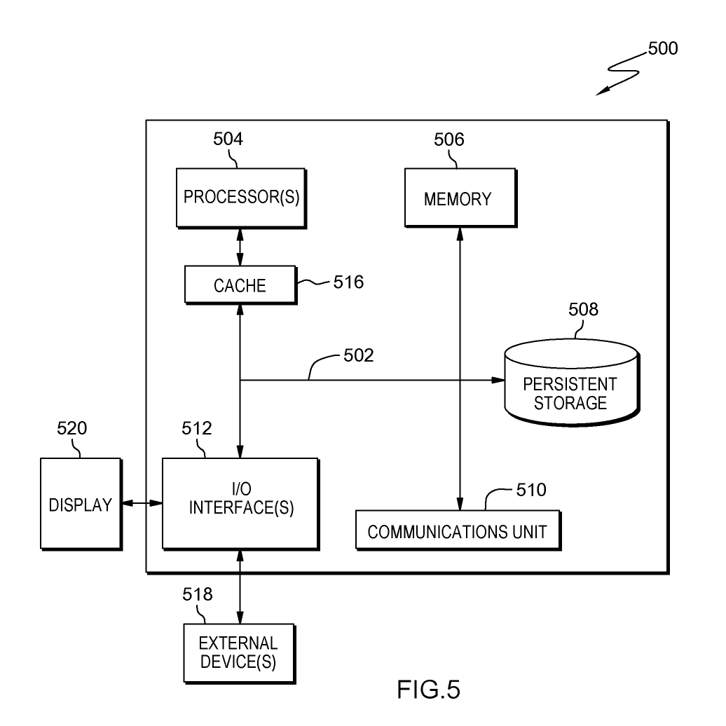

In another embodiment, survey design computer 102 represents a computing system utilizing clustered computers and components (e.g., database server computers, application server computers, etc.) that act as a single pool of seamless resources when accessed within survey design environment 100. Survey design computer 102 can include internal and external hardware components, as depicted and described in further detail with respect to FIG. 5. Survey design component 106 can be a framework for automatic or assisted generation of surveys on a topic specified by a survey designer.

Network 110 can be, for example, a local area network (LAN), a wide area network (WAN) such as the Internet, or a combination of the two, and can include wired, wireless, or fiber optic connections. In general, network 110 can be any combination of connections and protocols that will support communications between survey design computer 102 and user survey computer 104.

User survey computer 104 can be a standalone computing device, management server, a web server, a mobile computing device, or any other electronic device or computing system capable of receiving, sending, and processing data. In other embodiments, user survey computer 104 can represent a server computing system utilizing multiple computers as a server system. In another embodiment, user survey computer 104 can be a laptop computer, a tablet computer, a netbook computer, a personal computer, a desktop computer, or any programmable electronic device capable of communicating with other computing devices (not shown) within survey design environment 100 via network 110.

In another embodiment, user survey computer 104 represents a computing system utilizing clustered computers and components (e.g., database server computers, application server computers, etc.) that act as a single pool of seamless resources when accessed within survey design environment 100. User survey computer 104 can include internal and external hardware components, as depicted and described in further detail with respect to FIG. 5. It should be noted that user survey computer can be a plurality of user survey computers based on the number of users in the survey pool. User survey 108 can be a survey prepared by survey design component 106 and presented to a survey taker for completion.

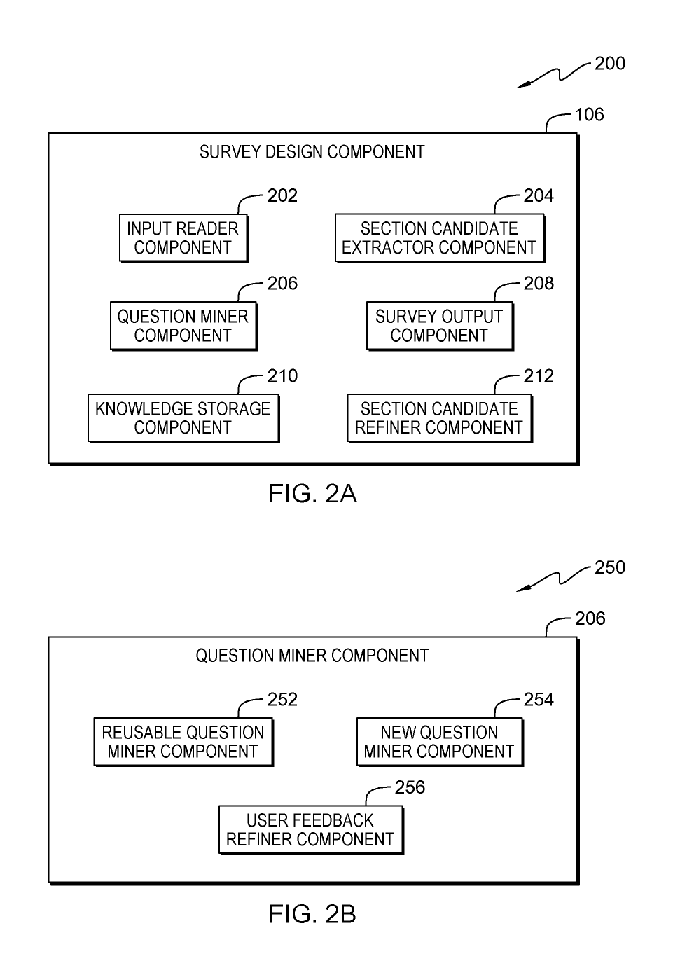

FIG. 2A is a functional block diagram 200 depicting survey design component 106 comprising input reader component 202, section candidate extractor component 204, question miner component 206, survey output component 208, knowledge storage component 210 and section candidate refiner component 212.

Input reader component 202 of an embodiment of the present invention provides the capability to read and collect input data such as, but not limited to, a survey designer selected topic title of the survey, a survey designer written topic description of the survey, a survey designer selected list of topic related documents, the name and/or address, i.e., identity, of information repositories, either online or offline, for searching by the survey design component 106, a survey designer selected desired number of questions per survey section and an optional threshold parameter for determining identified document relevance in relation to the selected survey topic. It should be noted that the input data described above can also be collected, either alone or simultaneously, from a section candidate refiner component 212 described below.

For example, a survey designer can provide the input reader component 202 a survey title of “Employee Engagement Survey,” a survey topic description of “measure and quantify those criteria such as ‘ownership’ of their work, dedication to corporate goals and customer service,” a survey list of topic related documents of “Health Plan Employee Survey and General Employee Survey,” the name of an information repository of “Wikipedia” and the number of questions per section of “2.” The input reader component 202 sends the collected information toward the section candidate extractor component for further processing. It should be noted that the survey sections are not specified by the survey designer, i.e., the number and names of the sections can be determined automatically.

The section candidate extractor component 204 provides the capability to extract a set of proposed sections covering a topic specified in the input provided to the input reader component 202. The section candidate extractor component 204 computes a set of the most distinct subtopics covering the provided topic and considers each subtopic as a section.

The subtopics, i.e., sections are determined by 1) extracting a list of important keywords characteristic to the input topic from the input associated with the input reader component 202; 2) generating a filtered list of the important keywords based on a threshold number of the most important keywords (w), e.g., the top 5 keywords; 3) expanding the filtered list by adding related words (e.g., synonyms of the keywords) in the filtered list to the filtered list; 4) performing a calculation between the expanded filtered list and the list of topic related documents from the input associated with the input reader (e.g., a Term Frequency—Inverse Document Frequency (TF-IDF) statistical calculation), i.e., corpuses, to determine a distance between the words in the expanded filtered list and the list of topic related documents wherein the calculation determines how important a word is to a document in an information repository and is well known to one skilled in the art; 5) searching the information repository for input topic relevant documents based on the distance value and the expanded filtered list; 6) extracting concepts from the relevant documents with a natural language processing (NLP) tool to create a condensed representation of the document (well known to one skilled in the art); 7) clustering the relevant documents based on shared concepts; 8) associating a score to each cluster and filtering out the clusters with low scores, e.g., a score is the maximum distance value between a cluster and the filtered list of important keywords ‘w’ with a predetermined minimum, e.g., 0.70, as a minimum accepted score; and 9) calculate a representation for each cluster of documents (e.g., a center as a list of most frequent and most representative words of the cluster; words of the important keywords ‘w’ present in the cluster and with the most frequent TF-IDF value). It should be noted that each representation of a cluster can represent a section and each section is characterized by factors such as, but not limited to, a section title selected as the most representative word of the cluster centroid, a list of concept words ‘C’, e.g., a list of words obtained from the NLP tool and a list of the most frequent and most representative keywords ‘w’ of the cluster. Further, the cluster representations, e.g., ‘C’ and ‘w’ are disposed to retrieve similar sections from the knowledge storage component 210 described subsequently, e.g., by analyzing the word/concept overlap, and can be leveraged by the designed in creating relevant sections.

Question miner component 206 provides the capability to receive the generated section names as input and generates questions for each of the provided sections. The question miner component can generate the question based on related questions from previous surveys or new questions unrelated to previous surveys. The question miner component separates the questions based on the provided section names.

Survey output component 208 provides the capability to assemble the sections and their associated questions into a survey for presentation to the survey taker. The survey output component 208 further provides the capability to interact with topic experts to refine the survey questions, e.g., the survey designer in some cases and/or a team of survey testers.

Knowledge storage component 210 provides storage and access to information such as, but not limited to, historical knowledge on existing surveys and corpuses, the current survey and information received from the user feedback minor component 252, discussed subsequently.

Section candidate refiner component 212 provides the capability to provide section candidate input to the input reader component 202 based on input from previous surveys mined from the knowledge storage component 210.

FIG. 2B is a functional block diagram 250 depicting question miner component 206 comprising reusable question miner component 252, new question miner component 254 and user feedback refiner component 212.

Reusable question miner component 252 provides the capability to mine the knowledge storage component 210 for questions from previous surveys that are applicable to the current survey. The question mining is based on section information provided by the question miner component 206. The reusable question miner component 252 uses the list of important keywords generated by the input reader component 202, the reusable question miner component 252 searches the knowledge storage component 210 for existing question from previous surveys that could be reused in the current survey, i.e., each stored survey is analyzed in two steps and the candidates with the higher score are selected.

One step determines if an existing survey is associated with a topic related to the new survey, if the existing and new surveys are related, e.g., the TF-IDF value with respect to the concepts extracted by the NLP tool, then the existing topic related survey is analyzed with a step that compares questions from the topic related survey based on words in the questions similar to the important keywords described above and returns a score, e.g. a hamming distance. Considering an optional analysis, the acceptable distance can be extended by considering related words of the important keywords based on an NLP tool (e.g., synonyms). The questions with a score greater than a threshold value are selected as the set of reusable questions. It should be noted that the threshold value is configurable.

In another aspect of reusable question selection, the reusable question miner component 252 can analyze the selected questions and determine the percentage that come from the same section of the previous survey. For example, if 50 percent of the questions came from the same section of the previous survey then the reusable question miner component 252 can select the remainder of the questions from that section, based on the presumption of a close relationship between the entire section and the current survey topic. The reusable question miner component 252 subtracts the number of reusable questions from the number of desired questions, specified by the input reader component, and if any further questions are required then the new question miner component 254 prepares the remaining questions.

New question miner component 254 provides the capability to generate new questions if reusable question miner component 252 is unable to generate sufficient questions. It should be noted that the new question miner component 254 can be employed to generate new questions even if reusable question miner component 252 finds a sufficient number of questions.

Accordingly, one or more sections have an insufficient number of questions based on input provided by the input reader component 202 and output provided by reusable question miner component 252. New question miner component 254 searches for external data, i.e., not in the knowledge storage component 210, relevant to the current survey topic and section. The new question miner component 254 can find external data by searching related documents in online sources such as, but not limited to, Wikipedia. The new question miner component 254 determines relatedness based on overlap between the discovered documents and the information representing a section, i.e., the list of concepts and important keywords of the cluster associated with the section. Continuing, parts of text (e.g., paragraphs) are retrieved form the mined documents and the new question miner component 254 formulates questions from them. It should be noted that a distance check, as described for the reusable question miner component 252 can be performed to insure that newly generated questions are not too similar to questions discovered by the reusable question miner component 254. It should be noted that determining if new questions are too close to existing questions can be accomplished with methods such as but not limited to textual entailment (TE) methods.

User feedback refiner component 256 provides the capability to improve the quality of questions provided by the reusable question miner component based on information provided by the user feedback miner component 302 (described subsequently) stored in the knowledge storage component 210. For example, user feedback indicating one or more mined questions are confusing for the current topic can lead to a rework of the confusing questions or the elimination of the questions from the current survey.

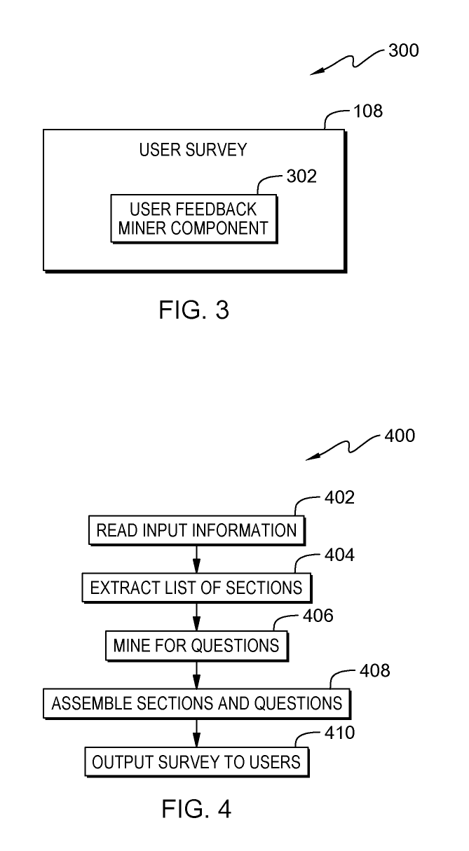

FIG. 3 is a functional block diagram 300 depicting user survey 108 comprising user feedback miner component 302. User feedback miner component 302 provides the capability to mine knowledge from the current survey based on the way users interact with the user survey 108 and their answers to the current survey questions. The user feedback miner component 302 can consider various metrics such as, but not limited to, comments provided as a free-form text entry by users, response time to different questions, total time required to complete the survey, survey response rate, survey question response speed, etc. For example, the user feedback miner component 302 records the metrics as a user takes the survey and begins the analysis when the user submits the survey. The analysis can include, but is not limited to, survey questions with the highest response time, survey question popularity score, survey questions with the greatest number of wrong answers, etc. The metrics collected by the user feedback miner component 302 can be sent toward the knowledge storage component for further analysis.

FIG. 4 is a flowchart of a method 400 depicting operational steps to automatically generate a survey based on a provided survey topic, in accordance with an embodiment of the present invention. Looking to step 402, input is collected by the input reader component 202 from a survey designer. Next, at step 404, the collected input is sent toward the section candidate extractor component 204 where the sections for the survey are determined. Next at step 406, the question miner component 206 mines questions for the extracted sections based on the requirements presented by the input collected in step 402. It should be noted that the question miner component can mine questions from the knowledge storage component 210 with the reusable question miner component 252 or from external data with the new question miner component 254 based on the requirements of the survey or based on a configuration provided by the survey designer.

Next, at step 408, the survey sections and their associated questions are assembled into a completed survey by the survey output component 208. The completed survey is provided to one or more user survey computers at step 410 wherein a survey taker can complete the survey.

Optionally, a user feedback miner component 302 can provide information associated with a user taken survey for improving the quality of the survey. The information can be analyzed by the user feedback refiner component 256 for survey question improvement. In another aspect of survey improvement, the section candidate refiner component 212 can improve the quality of the automatically generated sections.

FIG. 5 depicts computer system 500, an example computer system representative of survey design computer 102 and user survey computer 104. Computer system 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Computer system 500 includes processors 504, cache 516, memory 506, persistent storage 508, communications unit 510, input/output (I/O) interface(s) 512 and communications fabric 502. Communications fabric 502 provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data, and data near recently accessed data, from memory 506.

Program instructions and data used to practice embodiments of the present invention may be stored in persistent storage 508 and in memory 506 for execution by one or more of the respective processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to each computer system. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method for automatically generating a survey and improving the quality of the survey based on survey taker feedback, the computer-implemented method comprising:
receiving, by a survey generator computer, survey configuration information associated with a survey topic;
generating, by the survey generator computer, a plurality of survey sections, based on the survey configuration information, for the survey;
generating, by the survey generator computer, a plurality of survey questions, based on the configuration information and the plurality of survey sections wherein the survey questions are based on related questions from previous surveys and new questions unrelated to previous surveys and selected by a survey miner component;
generating, by the survey generator computer, a survey wherein the plurality of survey sections are associated with a portion of the plurality of survey questions, respectively;
outputting, by the survey generator computer, a survey towards one or more user survey computers, wherein a user takes the survey; and
improving, by the survey generator computer, quality of the survey by refining the plurality of survey questions based on received survey taker feedback wherein the survey taker feedback describes survey taker behavior while taking the survey.

2. The computer-implemented method of claim 1, wherein the survey configuration information comprises a survey title, a survey topic description and at least one of one or more documents associated with the survey topic, an identity of one or more information repositories and a number of survey questions per survey section.

3-4. (canceled)

5. The computer-implemented method of claim 2, wherein generating a plurality of survey questions further comprises:
selecting a plurality of existing questions associated with the survey topic from a database comprising questions associated with a plurality of previous surveys;
creating a plurality of new questions associated with the survey topic from related documents retrieved from one or more information repositories; and
organizing the plurality of existing questions and the plurality of new questions based on the plurality of survey sections.

6. The computer-implemented method of claim 5, wherein selecting a plurality of existing questions further comprises:
determining if one or more previous survey topics are related to the survey topic; and
responsive to, the one or more previous survey topics being related to the survey topic, selecting questions associated with the one or more previous survey topics based on a natural language processing tool.

7. The computer-implemented method of claim 5, wherein creating a plurality of new questions further comprises:
mining related documents in the one or more information repositories based on overlap between the related documents and the plurality of survey sections;
creating the plurality of new questions based on retrieving a portion of the related documents; and
filtering the plurality of new questions such that the plurality of new questions are different from the plurality of existing questions.

8. A computer program product for automatically generating a survey and improving the quality of the survey based on survey taker feedback, the computer program product comprising:
one or more computer readable storage media and program instructions stored on the one or more computer readable storage media, the program instructions comprising:
program instructions to, receive, by a survey generator computer, survey configuration information associated with a survey topic;
program instructions to, generate, by the survey generator computer, a plurality of survey sections, based on the survey configuration information, for the survey;
program instructions to, generate, by the survey generator computer, a plurality of survey questions, based on the configuration information and the plurality of survey sections wherein the survey questions are based on related questions from previous surveys and new questions unrelated to previous surveys and selected by a survey miner component;
program instructions to, generate, by the survey generator computer, a survey wherein the plurality of survey sections are associated with a portion of the plurality of survey questions, respectively;
program instructions to, output, by the survey generator computer, a survey towards one or more user survey computers, wherein a user takes the survey; and
program instructions to, receive, by the survey generator computer, survey taker feedback based on survey taker behavior, and refining the plurality of survey questions to improve quality of the survey.

9. The computer program product of claim 8, wherein the survey configuration information comprises a survey title, a survey topic description and at least one of one or more documents associated with the survey topic, an identity of one or more information repositories and a number of survey questions per survey section.

10-11. (canceled)

12. The computer program product of claim 9, wherein generating a plurality of survey questions further comprises:
program instructions to, select a plurality of existing questions associated with the survey topic from a database comprising questions associated with a plurality of previous surveys;
program instructions to, create a plurality of new questions associated with the survey topic from related documents retrieved from one or more information repositories; and
program instructions to, organize the plurality of existing questions and the plurality of new questions based on the plurality of survey sections.

13. The computer program product of claim 12, wherein selecting a plurality of existing questions further comprises:
program instructions to, determine if one or more previous survey topics are related to the survey topic; and
responsive to, the one or more previous survey topics being related to the survey topic, program instructions to, select questions associated with the one or more previous survey topics based on a natural language processing tool.

14. The computer program product of claim 12, wherein creating a plurality of new questions further comprises:
program instructions to, mine related documents in the one or more information repositories based on overlap between the related documents and the plurality of survey sections;
program instructions to, create the plurality of new questions based on retrieving a portion of the related documents; and
program instructions to, filter the plurality of new questions such that the plurality of new questions are different from the plurality of existing questions.

15. A computer system for automatically preparing a survey and improving the quality of the survey based on survey taker feedback, the computer system comprising:
one or more computer processors;
one or more computer readable storage media;
program instructions stored on the one or more computer readable storage media for execution by at least one of the one or more computer processors, the program instructions comprising:
program instructions to, receive, by a survey generator computer, survey configuration information associated with a survey topic;
program instructions to, generate, by the survey generator computer, a plurality of survey sections, based on the survey configuration information, for the survey;
program instructions to, generate, by the survey generator computer, a plurality of survey questions, based on the configuration information and the plurality of survey sections wherein the survey questions are based on related questions from previous surveys and new questions unrelated to previous surveys and selected by a survey miner component;
program instructions to, generate, by the survey generator computer, a survey wherein the plurality of survey sections are associated with a portion of the plurality of survey questions, respectively;
program instructions to, output, by the survey generator computer, a survey towards one or more user survey computers, wherein a user takes the survey; and
program instructions to, receive, by the survey generator computer, survey taker feedback based on survey taker behavior, and refining the plurality of survey questions to improve quality of the survey.

16. The computer system of claim 15, wherein the survey configuration information comprises a survey title, a survey topic description and at least one of one or more documents associated with the survey topic, an identity of one or more information repositories and a number of survey questions per survey section.

17. (canceled)

18. The computer system of claim 16, wherein generating a plurality of survey questions further comprises:
program instructions to, select a plurality of existing questions associated with the survey topic from a database comprising questions associated with a plurality of previous surveys;
program instructions to, create a plurality of new questions associated with the survey topic from related documents retrieved from one or more information repositories; and
program instructions to, organize the plurality of existing questions and the plurality of new questions based on the plurality of survey sections.

19. The computer system of claim 18, wherein selecting a plurality of existing questions further comprises:
program instructions to, determine if one or more previous survey topics are related to the survey topic; and
responsive to, the one or more previous survey topics being related to the survey topic, program instructions to, select questions associated with the one or more previous survey topics based on a natural language processing tool.

20. The computer system of claim 18, wherein creating a plurality of new questions further comprises:
program instructions to, mine related documents in the one or more information repositories based on overlap between the related documents and the plurality of survey sections;
program instructions to, create the plurality of new questions based on retrieving a portion of the related documents; and
program instructions to, filter the plurality of new questions such that the plurality of new questions are different from the plurality of existing.
